(19) United States
(12) Patent Application Publication
(10) Pub. No.: US 2012/0033711 A1
(43) Pub. Date: Feb. 9, 2012

(54) Metal ebulliometer with internal fluid recirculation

(76) Inventor: Pedro SUSIAL BADAJOZ, Las Palmas de Gran Canaria (ES)

(21) Appl. No.: 13/193,640

(22) Filed: Jul. 29, 2011

(30) Foreign Application Priority Data
Aug. 3, 2010 (ES) 201030827

(51) Int. Cl. G01K 7/02

(52) U.S. Cl. 374/179; 374/E07.004

(57) ABSTRACT

Metal ebulliometer with internal fluid recirculation which is used to study the Vapor-Liquid Equilibrium without requiring the use of any auxiliary external elements. It provides the advantages of glass equipment and, as it is made of metal, it allows working in pressures higher than the atmospheric pressure—in a range of up to approximately 10 bars. This invention can be manufactured in either copper or stainless steel, for example. The result is the design of a continuous and dynamic equipment in which both phases (Vapor-Liquid) can be recirculated.

### PURPOSE OF THE INVENTION

This invention, as drawn from the description of this specification, is a metal ebulliometer with internal fluid recirculation which is used to study the Vapor-Liquid Equilibrium without requiring the use of any auxiliary external elements. It provides the advantages of glass equipment and, as it is made of metal, it allows working in pressures higher than the atmospheric pressure—in a range of up to approximately 10 bars.

### BACKGROUND OF THE STATE OF THE TECHNIQUE

The behavior of mixtures of interest in separation processes, traditionally has been studied by determining the vapor-liquid equilibrium, and therefore the conditions of pressure, temperature and compositions of the phases The research equipment for this purpose has been developed for atmospheric pressure (low pressures) and therefore the equipment used and developed are numerous and varied. However, they are usually made of glass. They are mostly made of glass when the phases to be separated in the process are recirculated within the equipment. Therefore, the existent metal equipment used to work at moderate and high pressures is usually discontinuous or uses external elements for fluid recirculation.

With respect to the current status of technology in this matter, the Vapor Liquid Equilibrium has traditionally been developed at atmospheric pressure (low pressures), which is why the equipment used is usually made of glass.

A brief bibliographical review, considering those taken as a constructive reference, could be:
Ebulliometer by Gillespie (1946).
Dynamic chamber by Malanowski (1982).
Ebulliometer developed by Casiano de Afonso (1983).

At the present, there are different commercial equipment available:
The Labodest type, Model 602 glass dynamic ebulliometer can be used in a pressure range of 0.25 to 400 kPa.
The Pilodist VLE 100D dynamic ebulliometer can be used in a depression range of 0.1 to 300 kPa.

On the other hand, equipment used in high pressures have followed a different line of development as a result of discontinuous equipment being used approximately above 4 bar, these are mostly formed cells constructed in stainless steel and capable of operating at high pressures—between 14 to 3500 bar. A brief bibliographical review could be:

1. Static Systems (Non-Recirculated Phases):
Rogers (1970) with a volume of 150 ml and a work pressure of 1,000 bar.
Konrad (1982) with a volume of 100 ml and a work pressure of 2,000 bar.
Mfllhlbauer (1991) with a volume of 35 ml and a work pressure of 200 bar.
Galicia-Luna (2000) with a volume of 40 ml and a work pressure of 600 bar.

2. Dynamic Systems (One or Two Recirculated Phases):
King (1983) with a volume of 300 ml and a work pressure of 500 bar.
Inomata (1988) with a volume of 750 ml and a work pressure of 60 bar.
Fink (1990) with a volume of 60 ml.

With regard to the technique used in the “Metal Ebulliometer with internal fluid recirculation”, it provides the advantages of glass equipment when working at low pressures; it replaces glass with copper to work at overpressures; the joints are welded using silver; and it features a valve mechanism that allows introducing the mixture mix inside it when it is operating at overpressure. This factor is very useful as studying the Vapor-Liquid Equilibrium at high pressures is of great industrial interest because of, amongst other aspects, the azeotrope displacement that facilitates or even allows the complete separation of a mixture.

Another characteristic worth mentioning about this equipment is that joints are not required; joints can be sensitive to degradation at high work temperatures and due to the products used.

Therefore, the main advantages that this ebulliometer provides when compared to equipment operating at overpressures are the reduction of work time and chemicals consumption. This is due to maintaining the characteristics of low-pressure equipment, that is, working continuously and with recirculation in both phases.

Lastly, thanks to the malleability of copper and the simplicity of working, cutting and welding it, they can be modified easily and cheaply.

### EXPLANATION OF THE INVENTION

With the aim of achieving the objectives set and avoiding the inconveniences mentioned in previous sections, a new “Metal ebulliometer with internal fluid recirculation” is proposed to study the Vapor-Liquid Equilibrium. This invention can be manufactured in either copper or stainless steel, for example, all joints are welded using silver, and it features a similar configuration to the ebulliometer manufactured in glass by “Casiano de Afonso”. The result is the design of a continuous and dynamic equipment in which both phases can be recirculated.

The equipment has a double-walled inverted vessel from which extend a Cottrell tube at the top and another tube at the bottom that connects to the lower part of the equipment. The mixture is located in the space between both walls, and a heating resistor is placed in the vessel. The Cottrell tube extends upwards, outside the equipment, and enters it at the top. It then reaches the equilibrium chamber, which consists in an inverted vessel that initiates at the top of the chamber and includes a thermocouple. On its right are a second thermocouple and the inlet to a tube that extends out of the equipment's body—towards its bottom part with a fold in the middle—which connects to another vertical tube, that is surrounded by a coolant. On the bottom part is a tube surrounded by another with a larger diameter both ending at a valve, although the outer tube separates from the inner tube at the top and enters the equipment's body by means of a tube that has a fold in its middle part.

Below the equilibrium chamber is a cone that takes up the entire equilibrium chamber due to its larger diameter, allowing it to collect and channel the mixture. On the bottom is a tube that extracts it outwards and where there is a coolant and then a valve. The tube coming from the coolant becomes concentric to another outer tube that surrounds it until reaching the valve. The outer tube goes from the valve to a second coolant which is at the top; it enters into the equipment's body again by means of a bend that is next to its wall and is directed to the bottom part of the equipment.

The equipment's body gradually reduces in diameter until forming a tube that passes through a coolant and reaches a valve. This tube is surrounded by another outer tube that envelopes it and from which extends another ascending tube—at the top part of the coolant—in an approximately 40° angle, linking the double-walled inverted vessel.

Next to the thermocouples, but a bit further away from the equilibrium chamber, is a tube surrounded by a coolant. Where the coolant ends, there is a valve, then a damping chamber comprised of two tubes with identical diameters at their ends as well as a tube with a larger diameter in the center, and, lastly, another valve and a cone.

### DESCRIPTION OF THE DRAWINGS

As a complement to the description and with the aim of providing further insight on the invention's characteristics, the following figures are provided as practical examples of preferred embodiments:

FIG. 1.—Elevation view of the “Metal ebulliometer with internal fluid recirculation” as per the main elevation of the double-walled inverted vessel in which a gaseous mixture is produced.

FIG. 2.—Elevation view of the “Metal ebulliometer with internal fluid recirculation” as per the main elevation of the sampling and liquid and vapor recirculation systems, respectively.

The following elements or parts are worth mentioning:

1. Inverted vessel.

2. Cottrell tube.

3. Equilibrium chamber.

4. Equilibrium chamber's thermocouple.

5. Thermocouple located between the equilibrium chamber and the outer casing.

6. Substance loading valves.

7. Damping tank.

8. Main heat exchanger.

9. Sample collecting valve for vapor.

10. Sample collecting valve for liquid.

11. Channeling cone

12. Discharge valve.

### EXAMPLE OF PREFERRED EMBODIMENT

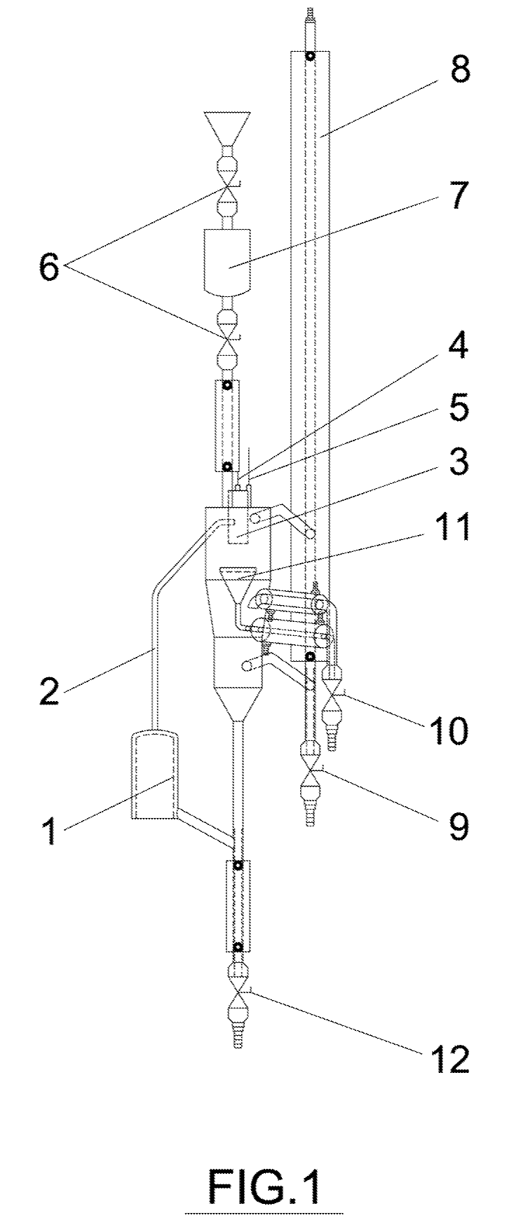

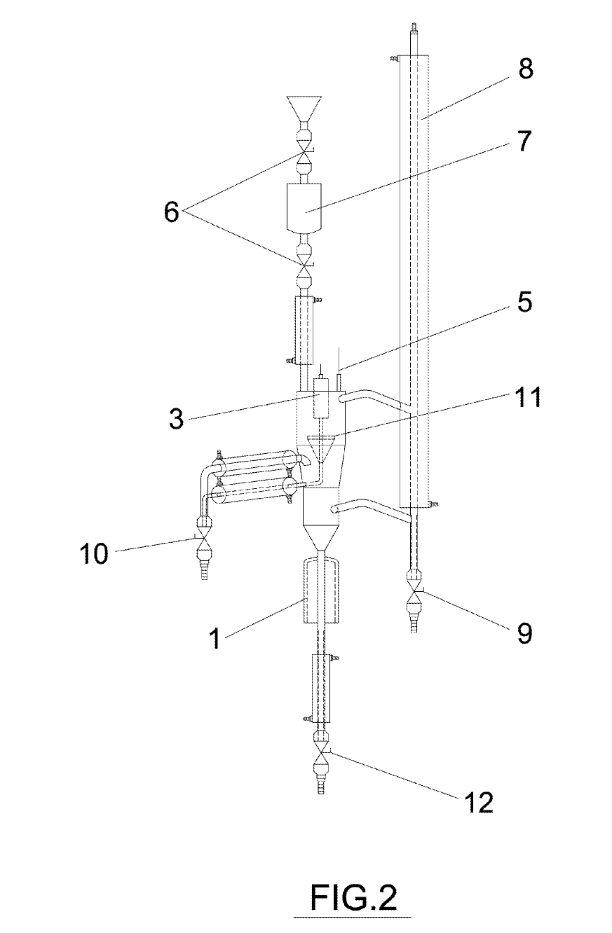

As an example of preferred embodiments of the “Metal ebulliometer with internal fluid recirculation”, FIG. 1 and FIG. 2 shows how it is designed from a double-walled inverted vessel (1) in which a gaseous mixture is produced. The mixture travels upwards through the Cottrell tube (2) and reaches an inverted vessel, which acts as an equilibrium chamber (3). There is a thermocouple at the top of this chamber (4). The equipment's body surrounds the chamber, which is where the second thermocouple (5) and the substance loading area are located. The loading area consists of a funnel, two valves (6), a damping chamber (7) and a heat exchanger, which by means of both valves allows the new mixture to enter the equipment when it is working at overpressure.

The channeling of the liquid and vapor phases and condensation take place in the equilibrium chamber (3).

The vapor is moved towards the right of the equipment, where the largest heat exchanger is located (8). The top part of the heat exchanger shall have a pressure inlet and the bottom part a vapor sample collector (9). An inner tube shall be installed inside the heat exchanger to guarantee an appropriate homogenization and that will take the vapor produced to the top part of the valve, which will make the mixture verflow through the tube that links the vapor outlet to the equipment's main body.

On the left part of the equipment, there is a valve from which a liquid sample can be obtained (10)—preceded by a heat exchanger—that ends inside the equipment's body by means of a funnel (11) that simplifies channeling in the liquid phase. The top part has a tube that recirculates the mixture just like in the vapor phase, that is, the liquid that falls into the funnel and is not sampled re-enters and falls to the bottom of the equipment's body.

The inverted vessel's inlet is located at the bottom part of the equipment, which is preceded by a heat exchanger with a concentric tube inside which operates the same as the one located in the vapor and liquid area. This concentric tube collects the mixture that comes from the equipment's body and recirculates it to the lowest part so the liquid entering the inverted vessel is completely mixed. Following the heat exchanger is a valve (12) whose function is to simplify emptying the equipment.

A more comprehensive description is not required for any expert to understand the reach of this invention and the advantages arising from its use. When implementing this technology, the design, the dimensions of the elements described and the materials used in its manufacture can be different provided that they do not alter the invention's essence.

1. Metal ebulliometer with internal fluid recirculation is manufactured in metal and designed as a continuous and dynamic equipment where both phases can be recirculated. It consists of the following main elements:
A. A double-walled inverted vessel from which extend a Cottrell tube at the top and another tube at the bottom that connects to the lower part of the equipment. The mixture is located in the space between both walls, and a heating element is placed in the vessel. The Cottrell tube extends upwards, outside the equipment, and enters it at the top. It then reaches the equilibrium chamber, which consists of an inverted vessel that initiates at the top of the chamber and includes a thermocouple. On its right are a second thermocouple and an inlet to a tube that extends out of the equipment's body—towards its bottom part with a fold in the middle—and that connects to another vertical tube, which is surrounded by a coolant. On the bottom part are a tube surrounded by another with a larger diameter, both ending at a valve, although the outer tube separates from the inner tube at the top and enters the equipment's body by means of a tube that has a fold in its middle part.
B. Below the equilibrium chamber is a cone that takes up the entire equilibrium chamber due to its larger diameter, allowing it to collect and channel the mixture. On the bottom is a tube that extracts it outwards and where there is a coolant and then a valve. The tube coming from the coolant becomes concentric to another outer tube that surrounds it until reaching the valve. The outer tube goes from the valve to a second coolant which is at the top; it enters into the equipment's body again by means of a bend that is next to its wall and is directed to the bottom part of the equipment.
C. The equipment's body gradually reduces in diameter until forming a tube that passes through a coolant and reaches a valve. This tube is surrounded by another outer tube that envelopes it and from which extends another ascending tube—at the top part of the coolant—in an approximately 40° angle, linking the double-walled inverted vessel.
D. Next to the thermocouples, but a bit further away from the equilibrium chamber, is a tube surrounded by a coolant. Where the coolant ends, there is a valve, then a damping chamber comprised of two tubes with identical diameters at their ends as well as a tube with a larger diameter in the center, and, lastly, another valve and a cone.
